(19) United States
(12) Patent Application Publication
(10) Pub. No.: US 2025/0361982 A1
(43) Pub. Date: Nov. 27, 2025

(54) LUBRICATION UNIT FOR A JOINING MODULE AND METHOD FOR LUBRICATING A JOINING MODULE USING SUCH A LUBRICATION UNIT

(71) Applicant: Kistler Holding AG, Winterthur (CH)

(72) Inventor: Chang LIU, Donzdorf (DE)

(21) Appl. No.: 19/217,256

(22) Filed: May 23, 2025

(30) Foreign Application Priority Data
May 27, 2024 (EP) 24178188.9

(51) Int. Cl. F16N 21/00; F16H 57/04; F16N 1/00

(52) U.S. Cl. CPC F16N 21/00; F16H 57/0497; F16N 1/00

(57) ABSTRACT

A joining module includes a screw drive, a spindle and a housing. The screw drive includes a tappet that can be moved along a linear movement by a nut. A lubrication unit is arranged on the housing and includes a lubricant in at least one lubrication unit channel. The nut includes at least one nut channel and at least one lubrication point arranged so that the nut can be moved into a lubrication position in which the nut and the lubrication unit are in direct mechanical contact with each other and the lubrication unit channel and the nut channel communicate with each other and so that the lubricant passes from the lubrication unit channel into the nut channel and then to the lubrication point.

### FIELD OF THE INVENTION

The invention relates to a lubrication unit for a joining module and to a method for lubricating a joining module using such a lubrication unit.

### BACKGROUND OF THE INVENTION

Joining modules are used in industrial production for a wide range of assembly and joining processes such as stamping, punching, riveting, clinching, etc. A joining module is used to move a tool required for an assembly and joining process into a workpiece and to apply the force required for the assembly and joining process. Joining modules are available as electromechanical, pneumatic or hydraulic modules.

A joining module comprises a drive, a screw drive, a tappet and a housing. The drive is operatively connected to the screw drive and a rotary movement of the drive is converted into a linear movement by means of the screw drive. Said tappet is attached to the screw drive and is moved with the linear movement. The tappet carries said tool or workpiece. The required force is applied via the tappet. The screw drive and the tappet are arranged in the housing.

For high-precision industrial production, said joining module exhibits a stroke length of several 100 mm, a high travel speed of 400 mm/s, a high stroke rate of more than 10 strokes/min and a high repeat accuracy of 0.01 mm. The joining module is designed for a long service life with more than 10⁶ strokes.

To ensure the functionality of the joining module, said movable screw drive must be lubricated with a lubricant such as oil or grease. For this purpose, the lubricant is applied to a lubrication point of the screw drive by means of a lubrication unit

The document WO01/033133A1, which is related to U.S. Pat. No. 6,695,590, which is hereby incorporated herein for all purposes by this reference, shows such a lubrication unit. The lubricant to be applied is encapsulated in a chamber. Pressure is exerted on the capsule via a compression spring arranged on the chamber and the lubricant is pressed out of the capsule into the chamber. Said chamber is connected to a large number of outlets via an axial bore. The lubricant flows into the axial bore. A non-return valve prevents the lubricant from flowing out of the axial bore back into the chamber. A piston is moved in the axial bore. Depending on the direction of the piston movement, the lubricant is sucked into the axial bore and pumped through the outlets. Additional non-return valves at the outlets prevent the lubricant from flowing out of the outlets back into the axial bore. The lubricant is applied to the lubrication point via the outlets.

The lubrication unit known from document WO01/033133A1 is expensive to manufacture due to the many non-return valves required and takes up a lot of space.

### OBJECTS AND SUMMARY OF THE INVENTION

Among the desired objects of the present invention are to create an economic and space-saving lubrication unit for a joining module and a method for lubricating a joining module using such a lubrication unit.

At least one of these objects has been achieved by the features described herein.

The invention relates to a lubrication unit for a joining module, which joining module comprises a screw drive, a tappet and a housing, which screw drive comprises a nut, which tappet can be moved by the nut with a linear movement; which lubrication unit is arranged on the housing and exhibits lubricant in at least one lubrication unit channel; which nut comprises at least one nut channel and at least one lubrication point; wherein the nut may be moved into a lubrication position, in which lubrication position the nut and the lubrication unit are in direct mechanical contact with each other and the lubrication unit channel and the nut channel communicate with each other and lubricant passes from the lubrication unit channel into the nut channel and from there to the lubrication point.

The invention also relates to a method for lubricating a joining module, which joining module comprises a screw drive, a tappet and a housing, which screw drive comprises a nut, which tappet may be moved by the nut with a linear movement; with a lubrication unit, which lubrication unit is arranged on the housing and comprises lubricant in at least one lubrication unit channel; which nut comprises at least one nut channel and at least one lubrication point; wherein the nut is moved into a lubrication position, in which lubrication position said nut and the lubrication unit are in direct mechanical contact with each other and the lubrication unit channel and the nut channel communicate with each other and lubricant passes from the lubrication unit channel into the nut channel and from there to the lubrication point.

Compared to the lubrication unit of document WO01/033133A1, the lubrication unit according to the invention does not require non-return valves for lubricating said joining module and is therefore economic and space-saving. Only when the nut is moved into the lubrication position and the nut and the lubrication unit are in direct mechanical contact with each other said lubrication unit channel and said nut channel begin to communicate with each other and lubricant reaches the lubrication point. This means that as long as the nut or as soon as the nut is no longer moved into the lubrication position, there is no communication between said lubrication unit channel and said nut channel and lubricant cannot flow back from the nut channel into the lubrication unit channel.

Advantageous embodiments of the inventions are described herein.

### BRIEF DESCRIPTION OF THE DRAWINGS

In the following, the invention is explained in more detail using an exemplary embodiment with reference to the figures in which:

FIG. 1 schematically shows a section A-A cut longitudinally through the XY plane of a part of a joining module 1 comprising a lubrication unit 50;

FIG. 2 schematically shows an enlarged portion of the section A-A cut transversely through the XY plane of the lubrication unit 50 according to FIG. 1 in the closed state; and

FIG. 3 schematically shows an enlarged portion of a section cut transversely through the XY plane of the lubrication unit 50 according to FIG. 1 in the open state.

Throughout the figures, identical reference numerals denote identical objects in the figures.

### DETAILED DESCRIPTION OF EXEMPLARY EMBODIMENTS OF THE INVENTION

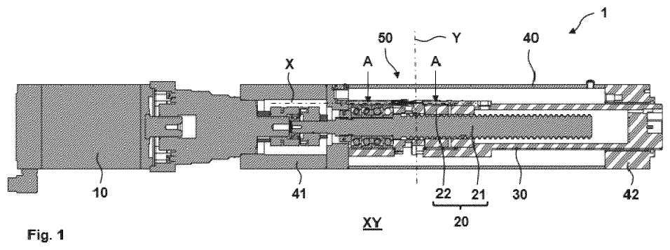

FIG. 1 schematically shows a part of an embodiment of a joining module 1. Said joining module 1 is shown in a sectional view in a plane XY spanned by a longitudinal axis X and a transverse axis Y. The longitudinal axis X and the transverse axis Y are perpendicular to each other.

Said joining module 1 comprises a drive unit 10, a screw drive 20, a tappet 30 and a housing 40 schematically shown in FIG. 1.

Said drive unit 10 is suitably configured and disposed to perform the function of moving the tappet 30 and applying a force via said tappet 30. The force is used to perform an assembly and joining process such as stamping, punching, riveting, clinching, etc. in the context of industrial production. For this purpose, said drive unit 10 comprises a motor, a brake and a control unit. Said drive unit 10 can be an electric drive unit, a pneumatic drive unit or a hydraulic drive unit. A joining module 1 with an electric drive unit 10 is characterized by high energy efficiency.

Said drive unit 10 is operatively connected to the screw drive 20. Said screw drive 20 has the function of converting a rotary movement of the drive unit 10 into a linear movement. For this purpose, said screw drive 20 comprises a spindle 21 and a nut 22. Said spindle 21 and the nut 22 are made of a mechanically resistant material such as steel, stainless steel, cast iron, etc. each of the exterior of the spindle 21 and the interior of the nut 22 defines matching threads that provide threaded rotational engagement between the spindle 21 and the nut 22. Said nut 22 sits on the spindle 21. The spindle 21 is connected to the drive unit 10 in a torque-proof manner, which means that they both rotate in unison and without relative rotation, in other words as if they constituted a single unitary structure. The spindle 21 is connected to the drive unit 10 by suitable means such as screws, press-fitting, etc. The rotary movement of the drive unit 10 causes a linear movement of the nut 22 by virtue of the aforementioned mutual threaded engagement between the spindle 21 and the nut 22. The linear movement takes place along the longitudinal axis X. The stroke length of the linear movement can be several hundreds of millimeters (100 mm). A travel speed of 400 mm/s of the nut 22 relative to the spindle 21 can be achieved. The linear movement of the nut 22 relative to the spindle 21 can have a high stroke rate of over 10 strokes/min and a high repeat accuracy of 0.01 mm for each stroke.

Said tappet 30 exhibits the function of carrying a tool or workpiece required for the assembly and joining process. The tool or workpiece is not shown in the figures. The tool or workpiece is connected to the tappet 30. The tool or workpiece is connected to the tappet 30 using suitable means such as screws, clamping, etc. Said tappet 30 is made of a mechanically resistant material such as steel, stainless steel, cast iron, etc. The tappet 30 is attached to the screw drive 20 via attachment to the non-thread exterior surface of the nut 22. The tappet 30 is arranged on a non-threaded side of the nut 22, i.e., the surface of the nut 22 facing away from the spindle 21. The tappet 30 is connected to said nut 22. The tappet 30 is connected to the nut 22 by suitable means such as screws, press fit, adhesive, etc., so that the nut 22 and the tppet do not rotate relative to each other. Accordingly, the tappet 30 is moved by the nut 22 in linear motion along the longitudinal axis X by the rotational movement that the drive unit 10 imparts to the spindle 21. Due to the linear movement that is thus imparted to the tappet 30, the tool or workpiece carried by the tappet 30 can be moved over a defined stroke length and the tappet 30 applies the force required for the assembly and joining process.

Said housing 40 schematically shown in FIG. 1 is configured and disposed to perform the function of protecting said screw drive 20 and said tappet 30 from harmful environmental influences such as contamination (dust, moisture, etc.). Such impurities can impair the functionality of said joining module 1. The housing 40 comprises a housing body made of a mechanically resistant material such as aluminum, steel, stainless steel, etc. Advantageously, the housing body is an extruded profile made of aluminum, aluminum alloys, etc. Said housing 40 is hollow cylindrical and comprises a cavity. Said screw drive 20 and the tappet 30 are located in the cavity. Said housing 40 radially encloses the screw drive 20 and the tappet 30. With respect to the longitudinal axis X, said housing 40 comprises a first housing end 41 defining a first opening and a second housing end 42 spaced apart along the longitudinal axis X from the first end 41 and defining a second opening. The first housing end 41 faces the drive unit 10, and the drive unit 10 projects into the housing 40 through the first opening. The second housing end 42 faces away from the drive unit 10, and the tappet 30 projects out of the housing 40 through the second opening. The first opening and the second opening are sealed against the ingress of impurities into the cavity defined internally of the housing 40 by suitable means such as sealing rings, etc.

Said joining module 1 comprises a lubrication unit 50. Said lubrication unit 50 is an independent assembly. It exhibits the function of lubricating the moveable screw drive 20 with a lubricant 56 such as oil or grease. The lubrication ensures the functionality of the joining module 1. This is because said joining module 1 is a durable capital good and is designed for a long service life with over 10⁶ strokes. Lubrication takes place at regular intervals over the service life. During lubrication, lubricant 56 is applied to at least one lubrication point between spindle 21 and nut 22.

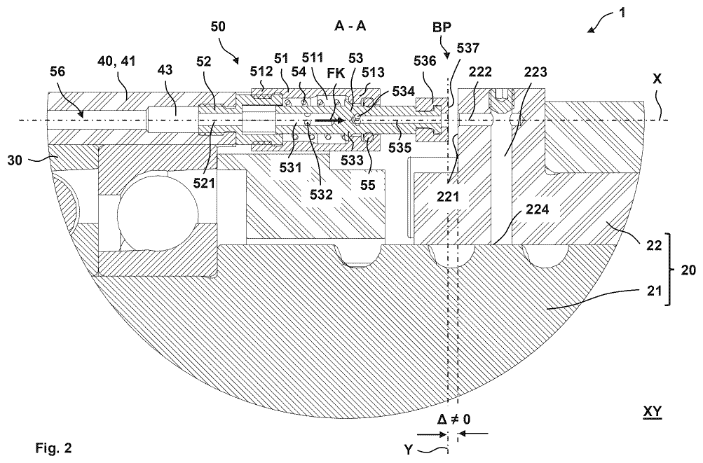

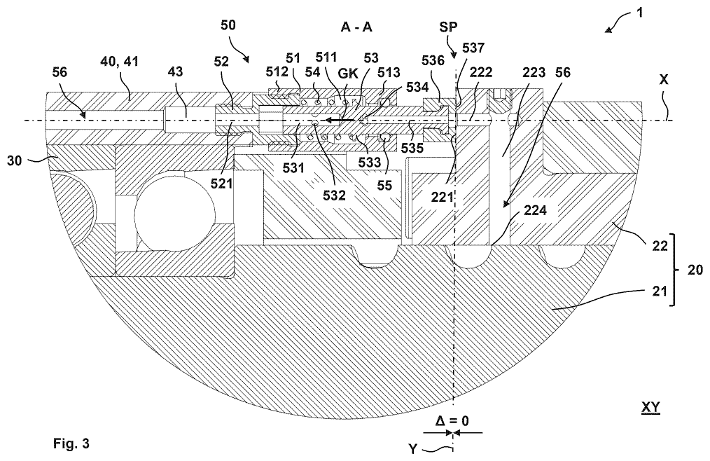

The lubrication unit 50 is arranged at the first housing end 41 of said joining module 1. FIGS. 2 and 3 show details of the exemplary embodiment of a part of the lubrication unit 50 according to FIG. 1. In FIGS. 2 and 3, the lubrication unit 50 is shown in a sectional view A-A. Section A-A runs along the longitudinal axis X.

Said lubrication unit 50 comprises a sleeve 51, an adapter 52, a line element 53 and a spring element 54. The sleeve 51, the adapter 52, the line element 53 and the spring element 54 are made of a mechanically resistant material such as aluminum, steel, stainless steel, etc.

Said sleeve 51 exhibits a hollow cylindrical form and defines an interior 511 therein as schematically shown in FIGS. 2 and 3 for example. With respect to the longitudinal axis X, said sleeve 51 defines a first sleeve end 512 and a second sleeve end 513 spaced apart from the first end 512 along the longitudinal axis X. The first sleeve end 512 faces the first housing end 41. The second sleeve end 513 faces the nut 22. The first sleeve end 512 defines an opening and the second sleeve end 513 defines an opening. Said interior 511 is accessible from outside the sleeve 51 through the openings in the sleeve ends 512, 513.

Said adapter 52 is attached to the first sleeve end 512. The adapter 52 is fastened to the first sleeve end 512 by suitable means such as material connection, positive connection, frictional connection and combinations thereof. In the exemplary embodiment of FIGS. 2 and 3, the adapter 52 is attached to the first sleeve end 512 by means of a screw connection, which when fully engaged, prevents relative movement of the adapter 52 relative to the first sleeve end 512 along the longitudinal axis X.

Said lubrication unit 50 can be connected and disconnected to the first housing end 41 via the adapter 52. Said adapter 52 is connected to the first housing end 41 by suitable means such as material connection, positive connection, frictional connection and combinations thereof. In the exemplary embodiment of FIGS. 2 and 3, the separate assembly of the lubrication unit 50 is configured via its adapter 52 to be selectively connected and disconnected to the first housing end 41 via a screw connection.

Said adapter 52 exhibits a hollow cylindrical form and defines a lubrication unit channel 521 extending internally therethrough along the longitudinal axis X with a first opening and a second opening defined at opposite ends of the adapter 52. The lubrication unit channel 521 in the adapter 52 is also referred to as adapter channel 521. In the state connected to the first housing end 41, the first opening of the adapter channel 521 faces away from the first sleeve end 512. In the state connected to the first housing end 41, the first opening of the adapter channel 521 forms an outer boundary of the lubrication unit 50 facing the first housing end 41 along the longitudinal axis X.

The first housing end 41 defines a housing channel 43. Said lubricant 56 is located in the housing channel 43.

The connection of the adapter 52 to the first housing end 41 is such that in the state connected to the first housing end 41, said housing channel 43 communicates with the adapter channel 521 and lubricant 56 passes, i.e., flows, without interruption from the housing channel 43 into the adapter channel 521.

The connection of the adapter 52 to the first housing end 41 is lubricant-tight. In the sense of the present invention, a connection or a direct mechanical contact of a first component with a second component is lubricant-tight if no lubricant 56 reaches the outside of the two components via the connection or the direct mechanical contact.

The line element 53 and the spring element 54 are arranged in said interior 511 of the sleeve 51.

Said line element 53 exhibits a cylindrical form and defines a first end facing the adapter 52 and a second end spaced apart from the first end and disposed facing the nut 22. Said line element 53 extends along the longitudinal axis X. With its first end, the line element 53 is located in the interior 511 of the sleeve 51, and with its second end, the line element 53 is located outside the interior 511 of the sleeve 51. The line element 53 extends out of interior 511 through the opening of the second sleeve end 513 of the sleeve 51. In the region of the opening of the second sleeve end 513, a radial outer side of the line element 53 is spaced apart with respect to the longitudinal axis X from a radial inner side of the second sleeve end 513 by a gap that is configured to permit sliding movement of the line element 53 along the longitudinal axis relative to the sleeve 51.

The lubrication unit 50 comprises a sealing element 55. Said sealing element 55 is arranged at the second sleeve end 513 and is configured and disposed to perform the function of sealing the gap between the radial outer side of the line element 53 and the opening of the second sleeve element 513 in a lubricant-tight manner. Said sealing element 55 is annular in its configuration with respect to the longitudinal axis X and consists of an elastical sealing material such as fluoroelastomer, perfluoroelastomer, acrylonitrile-butadiene rubber, etc.

The second sleeve end 513 defines an annular groove formed in the surface that defines the interior 511 of the sleeve 51. Said groove is configured and disposed to circumferentially surround the opening of the second sleeve end 513 in a completely radial manner. The groove is designed in such a way that it accommodates the radially outermost region of the sealing element 55 while permitting the innermost region of the sealing element 55 to radially project out of the groove into the gap and become disposed in direct mechanical contact with the outer surface of said line element 53. The sealing element 55 seals the gap in a lubricant-tight manner by means of sealing pressure. The sealing pressure can take the form of axial sealing pressure along the longitudinal axis X, or radial sealing pressure along the transverse axis Y, or a combination of both axial sealing pressure along the longitudinal axis X and radial sealing pressure along the transverse axis Y.

Said line element 53 defines at least one lubricant channel 531, 532, 534, 535. Preferably, the line element 53 defines several lubricant channels 531, 532, 534, 535. Said lubricant channels 531, 532, 534, 535 are also referred to as a first longitudinal channel 531, a second longitudinal channel 535, a first radial channel 532 and a second radial channel 534. Preferably, the line element 53 defines at least one first radial channel 532 and at least one second radial channel 534.

Said line element 53 defines the first longitudinal channel 531 and the first radial channel 532 in the region of its first end. The first longitudinal channel 531 runs inside the line element 53 along the longitudinal axis X and defines an opening. The opening of the first longitudinal channel 531 faces the adapter element 52. The first longitudinal channel 531 communicates with the adapter channel 521. With respect to the longitudinal axis X, the first radial channel 532 extends from the first longitudinal channel 531 to the radial outer side of the line element 53 and communicates with the interior 511 of the sleeve 51. Said line element 53 is designed in such a manner that lubricant 56 passes from the adapter channel 521 into the first longitudinal channel 531 and from there through the first radial channel 532 into the interior 511 of the sleeve 51.

Said line element 53 defines the second radial channel 534 and the second longitudinal channel 535 in the region of its second end. In the state of the lubrication unit 50 according to FIG. 3, the first radial channel 532 and the second radial channel 534 communicate with each other via the interior 511 of the sleeve 51. With respect to the longitudinal axis X, the second radial channel 534 extends from the radial outer side of the line element 53 to the second longitudinal channel 535. Said second longitudinal channel 535 runs inside the line element 53 along the longitudinal axis X and comprises an opening. The opening of the second longitudinal channel 535 faces the nut 22.

As schematically shown in FIG. 3, said line element 53 is designed in such a manner that upon communication of the first radial channel 532 with the second radial channel 534, lubricant 56 in the interior 511 of the sleeve 51 passes from the first radial channel 532 into the second radial channel 534 and from there into the second longitudinal channel 535.

Said line element 53 defines a sealing surface 533. The sealing surface 533 faces the second sleeve end 513. Said sealing surface 533 is configured and disposed to project radially outwardly from the radial outer side of the line element 53 in a direction that is generally transverse with respect to the longitudinal axis X while remaining confined within the interior 511 of the sleeve 51. The configuration of the sealing surface 533 desirably is designed as a conically-shaped extension.

Said spring element 54 is spiral-shaped and winds around the line element 53 in a disposition that is radially located on the outside of the first end of the line element 53 with respect to the longitudinal axis X. Said spring element 54 is configured to generate a spring force FK during compression thereof as schematically indicated in FIG. 2 by the direction being pointed by a solid arrow designated FK. As schematically shown in FIGS. 2 and 3, said spring element 54 is designed in such a way that it mechanically pretensions the line element 53 along the longitudinal axis X against the sleeve 51 via sealing surface 533 with the spring force FK. Then, as schematically shown in FIG. 2, when said sealing surface 533 and the interior radial projection of the sleeve 51 at the second sleeve end 513 of the sleeve 51 are in direct mechanical contact with each other under the effect of the spring force FK in the interior 511 of the sleeve, the communication of the first radial channel 532 with the second radial channel 534 via the interior 511 of the sleeve 51 becomes interrupted in a lubricant-tight manner. The interruption of the communication of the first radial channel 532 with the second radial channel 534 can be seen in the state of the lubrication unit 50 according to FIG. 2, where the second radial channel becomes positioned so as to be incapable of communicating with the interior 511 of the sleeve and accordingly no lubricant 56 passes from the first radial channel 532 into the second radial channel 534.

Said line element 53 desirably is fitted with a stop 536. Said stop 536 desirably is arranged at the second end of the line element 53 facing the nut 22. In the exemplary embodiment of FIGS. 2 and 3, said stop 536 is a separate component and is radially fastened on the outside of the line element 53 with respect to the longitudinal axis X. Said stop 536 desirably is attached to the line element 53 by means of a press fit. With knowledge of the present invention, the person skilled in the art can also realize the fastening of the stop to the line element can be accomplished by means of screwing, bonding, etc. The person skilled in the art can also manufacture the line element and the stop as a unitary structure in one piece.

Said stop 536 is configured with a hollow interior and is desirably generally cylindrical in shape. The second longitudinal channel 535 extends along the longitudinal axis X through the stop 536. Said stop 536 defines a stop sealing surface 537. With respect to the longitudinal axis X, said stop sealing surface 537 faces the nut 22. In the state connected to the first housing end 41, the stop sealing surface 537 forms an outer boundary of the lubrication unit 50 facing the nut 22 along the longitudinal axis X. The transverse axis Y desirably extends in the plane of the stop sealing surface 537. With respect to the longitudinal axis X, said stop sealing surface 537 completely surrounds the opening of the second longitudinal channel 535 in a radial manner.

Said nut 22 can be moved into various positions with the linear movement along the longitudinal axis X. In an operating position BP of the nut 22 according to FIG. 2, the nut 22 is located at a distance Δ≠0 (not equal to zero) from the lubrication unit 50 with respect to the longitudinal axis X. The joining module 1 is operated in the operating position BP. During operation of said joining module 1, the nut 22 assumes many different operating positions with a distance Δ≠0 to the lubrication unit 50. In the operating position BP, the nut 22 and the lubrication unit 50 do not have any direct mechanical contact with each other due to the distance Δ≠0. On the other hand, in a lubrication position SP of the nut 22 according to FIG. 3, said nut 22 is located at a distance Δ=0 (equal to zero) from the lubrication unit 50 with respect to the longitudinal axis X. In the lubrication position SP, no operation of said joining module 1 takes place. In the lubrication position SP of the nut 22, lubrication of said screw drive 20 occurs. In the lubrication position SP, the nut 22 and the lubrication unit 50 are in direct mechanical contact with each other due to the distance Δ=0 between a nut sealing surface 221 of the nut 22 and the stop sealing surface 537 of the line element 53.

As schematically shown in FIGS. 2 and 3, said nut 22 defines a nut longitudinal channel 222 extending along the longitudinal axis X. The nut longitudinal channel 222 is defined by an opening. Said opening of the nut longitudinal channel 222 faces the lubrication unit 50. Said nut 22 defines a nut sealing surface 221. Said nut sealing surface 221 faces the lubrication unit 50. With respect to the longitudinal axis X, the nut sealing surface 221 completely surrounds the opening of the nut longitudinal channel 222 in a radial manner.

Said second longitudinal channel 535 and the nut longitudinal channel 222 are designed in such a manner that they communicate with each other upon direct mechanical contact between the nut 22 and the lubrication unit 50 when disposed in the lubrication position SP according to FIG. 3, and lubricant 56 passes from the second longitudinal channel 535 through the opening of the second longitudinal channel 535 into the opening of the nut longitudinal channel 222 and into the nut longitudinal channel 222.

The direct mechanical contact between the nut 22 and the lubrication unit 50 takes place via the stop sealing surface 537 and the nut sealing surface 221. The stop sealing surface 537 and the nut sealing surface 221 are designed in such a manner that upon direct mechanical contact of said nut 22 and the lubrication unit 50, they seal the communication of the second longitudinal channel 535 with the nut longitudinal channel 222 in a lubricant-tight manner. This sealing of the second longitudinal channel 535 communicating with the nut longitudinal channel 222 can be seen in the state of the lubrication unit 50 according to FIG. 3, where no lubricant 56 from the second longitudinal channel 535 communicating with the nut longitudinal channel 222 reaches the outside of the lubrication unit 50.

As schematically shown in FIGS. 2 and 3, said nut 22 defines a nut transverse channel 223 extending along the transverse axis Y. The nut longitudinal channel 222 and the transverse nut channel 223 communicate with each other. The nut transverse channel 223 leads to at least one lubrication point 224 of the spindle. Lubricant 56, which is located in the nut longitudinal channel 222, passes from the nut longitudinal channel 222 into the nut transverse channel 223 and from there to the lubrication point 224 of the spindle.

Said nut longitudinal channel 222 and the nut transverse channel 223 combine to form one continuous channel within the nut 22 and accordingly are also referred to as at least one nut channel 222, 223.

Upon direct mechanical contact of nut 22 and lubrication unit 50 during the disposition of lubrication position SP according to FIG. 3, said nut 22 exerts a counterforce GK on the line element 53 along the longitudinal axis X as schematically indicated by the direction being pointed by a solid arrow designated GK. The counterforce GK of the nut 22 acts against the spring force FK of the spring element 54. A counterforce GK, which is greater than the spring force FK, displaces said line element 53 along the longitudinal axis X in the direction of the first housing end 41 and releases the sealing surface 533 from the sleeve 51. A counterforce GK, which is greater than the spring force FK, thus abolishes the interruption of the communication of the first radial channel 532 with the second radial channel 534 in the interior 511 of the sleeve 51.

In contrast, in the operating position BP according to FIG. 2, said nut 22 and the lubrication unit 50 are not in direct mechanical contact with each other and the nut 22 does not exert any counterforce GK on the line element 53. As long as said nut 22 has not moved into the lubrication position SP, the counterforce GK cannot act on the line element 53. Without counterforce GK, only the spring force FK of said spring element 54 then acts on the line element 53 and mechanically clamps the sealing surface 533 along the longitudinal axis X against the sleeve 51 and interrupts the communication of the first radial channel 532 with the second radial channel 534 in the interior 511 of the sleeve 51.

### LIST OF REFERENCE NUMERALS

1 Joining module
10 Drive unit
20 Screw drive
21 Spindle
22 Nut
221 Nut sealing surface
222 Nut longitudinal channel
223 Nut traverse channel
224 Lubrication point
30 Tappet
40 Housing
41 first housing end
42 second housing end
43 Housing channel
50 Lubrication unit
51 Sleeve
511 Interior
512 first sleeve end
513 second sleeve end
52 Adapter
521 Adapter channel
53 Line element
531 first longitudinal channel
532 first radial channel
533 sealing surface
534 second radial channel
535 second longitudinal channel
536 Stop
537 Stop sealing surface
54 Spring element
55 Sealing element
56 Lubricant
A-A Sectional view
BP Operating position
Δ Distance
FK Spring force
GK Counterforce
SP Lubrication position
X Longitudinal axis
XY Plane
Y Transverse axis

What is claimed is:

1. Lubrication unit disposable in the housing of a joining module, wherein the housing contains a screw drive with a nut defining at least one lubrication point, wherein the screw drive includes a tappet that can be moved in a linear movement by the nut, the lubrication unit comprising:
a lubrication body defining at least one lubrication unit channel therein;
a lubricant disposed in the at least one lubrication unit channel;
at least one nut channel defined in the nut;
at least one lubrication channel defined in the nut and defining a first end connected to the at least one nut channel defined in the nut;
wherein the at least one lubrication point of the nut is disposed spaced apart from the first end of the at least one lubrication channel defined in the nut;
wherein the nut is disposable into a lubrication position in which the nut and the lubrication body are in direct mechanical contact with each other and the at least one lubrication unit channel communicates with the at least one nut channel so as to permit lubricant to pass successively from the at least one lubrication unit channel into the at least one nut channel, from the at least one nut channel into the at least one lubrication channel defined in the nut and from the at least one lubrication channel defined in the nut to the lubrication point.

2. Lubrication unit according to claim 1, wherein the lubrication body includes a sleeve elongating along a longitudinal axis and defining an interior thereof, a line element defining a first end thereof and a second end thereof disposed spaced apart from the first end along the longitudinal axis, and a spring element;
wherein the first end of the line element and the spring element are arranged in the interior of the sleeve;
wherein the first end of the line element defines a sealing surface; and
wherein the unless the nut is disposed in the lubrication position, said spring element is configured and disposed within the interior of the sleeve to mechanically pretension the sealing surface with a spring force against the sleeve in a lubricant-tight manner that prevents the lubricant from moving from the at least one lubrication unit channel to the at least one nut channel.

3. Lubrication unit according to claim 2, wherein when said nut is disposed in the lubrication position, the second end of the line element exerts a counterforce against the spring force sufficient to overcome the spring force and allow lubricant in the lubrication unit channel to enter the at least one nut channel.

4. Lubrication unit according to claim 3, when said nut is disposed into the lubrication position, the line element and the spring are configured and disposed along the longitudinal axis so as to release the mechanical pretension of the sealing surface against the sleeve.

5. Lubrication unit according to claim 1, wherein said lubrication unit comprises a stop; wherein the lubrication unit channel extends through the stop; wherein the stop defines a stop sealing surface facing said nut; wherein said nut defines a nut sealing surface facing the lubrication unit; and wherein the stop sealing surface and the nut sealing surface are configured and disposed to seal the communication of the lubrication unit channel with the nut channel in a lubricant-tight manner upon direct mechanical contact between the nut and the lubrication unit.

6. Lubrication unit according to claim 1, wherein said housing defines a first housing end with a housing channel, in which housing channel lubricant is located; wherein said lubrication unit comprises a sleeve and an adapter; wherein the sleeve comprises a first sleeve end facing the first housing end; wherein said adapter is fastened to the first sleeve end; and wherein said lubrication unit is configured and disposed to be selectively connected to the first housing end via the adapter.

7. Lubrication unit according to claim 6, wherein said adapter defines an adapter channel therein; and wherein, when the adapter is connected to the first housing end, said housing channel communicates with the adapter channel and lubricant passes from the housing channel into the adapter channel of the adapter.

8. Lubrication unit according to claim 7, wherein said lubrication unit comprises a line element; wherein said line element defines a first end facing the adapter; wherein said sleeve defines an interior and the line element is arranged with its first end in the interior; wherein said line element defines at least one lubrication unit channel in the region of its first end; and wherein the lubrication unit channel of the line element communicates with said lubrication unit channel of the adapter so as to permit the passage of lubricant from the lubrication unit channel of the adapter into the lubrication unit channel of the line element.

9. Lubrication unit according to claim 8, wherein said line element defines a second end facing the nut; wherein said line element is arranged with its second end outside the interior; wherein said line element defines at least one lubrication unit channel in the region of its second end; and wherein upon communication of the lubrication unit channel in the region of the first end of the line element with the lubrication unit channel in the region of the second end of the line element, lubricant is permitted to pass from the lubrication unit channel in the region of the first end of the line element into the lubrication unit channel in the region of the second end of the line element.

10. Lubrication unit according to claim 9, wherein said lubrication unit channel extends into the interior in the region of the first end of said line element; wherein said lubrication unit channel extends into the interior in the region of the second end of the line element; and wherein the communication of the lubrication unit channel in the region of the first end of the line element with the lubrication unit channel in the region of the second end of the line element in the interior can be interrupted by displacement of the line element relative to the sleeve.

11. Lubrication unit according to claim 6, wherein said sleeve defines an interior and a second sleeve end facing the nut; wherein the second sleeve end defines an opening; wherein the lubrication unit comprises a line element; wherein said line element defines a first end and is arranged with its first end in the interior; wherein said line element extends out of the interior through the opening of the second sleeve end; wherein, in the region of the opening of the second sleeve end, a radial outer side of said line element is spaced apart from a radial inner side of the second sleeve end by a gap; and wherein said lubrication unit comprises a sealing element arranged at the second sleeve end so as to seal the gap in a lubricant-tight manner.

12. Method for lubricating a joining module with a lubrication unit, which joining module includes a screw drive, a tappet and a housing, which screw drive includes a nut, which tappet is configured and disposed to be moved by said nut with a linear movement, which lubrication unit is arranged on the housing and includes lubricant in at least one lubrication unit channel; which nut comprises at least one nut channel and at least one lubrication point, the method comprising the steps of:
moving said nut into a lubrication position in which said nut and the lubrication unit are in direct mechanical contact with each other;
aligning the lubrication unit channel and the nut channel to communicate with each other;
passing lubricant from the lubrication unit channel into the nut channel; and
passing lubricant from the nut channel to the lubrication point.

13. Method according to claim 12, wherein said lubrication unit comprises a sleeve, a line element and a spring element, which sleeve defines an interior and a first end of the line element and the spring element are arranged in the interior, which first end of said line element comprises at least one sealing surface, and wherein, as long as the nut is not moved into the lubrication position, said spring element is designed in such a manner that it mechanically pretensions the sealing surface with a spring force against said sleeve in the interior and interrupts a communication in the lubrication unit channel in a lubricant-tight manner.

14. Method according to claim 13, wherein said nut moved into the lubrication position exerts a counterforce on a second end of the line element, which counterforce acts against the spring force; and wherein a counterforce which is greater than the spring force abolishes the interruption of the communication in the lubrication unit channel.
